(19) United States
(12) Patent Application Publication
(10) Pub. No.: US 2017/0327986 A1
(43) Pub. Date: Nov. 16, 2017

(54) FABRIC WITH DYNAMIC VISUAL EFFECT

(71) Applicant: TIONG LIONG INDUSTRIAL CO., LTD., Taichung City (TW)

(72) Inventors: Chung-Hu HSIAO, Taichung City (TW); Den-Yong LIN, Taichung City (TW)

(21) Appl. No.: 15/155,666

(22) Filed: May 16, 2016

(51) Int. Cl. D06C 23/00; B32B 5/02; B32B 3/30; B32B 5/14; B44F 7/00; B32B 5/26

(52) U.S. Cl. CPC D06C 23/00; B44F 7/00; B32B 5/26; B32B 3/30; B32B 5/142; B32B 5/028; B32B 2451/00

(57) ABSTRACT

A fabric includes a base, a pattern layer provided on the base, a spacer layer provided on the pattern layer, and a mesh fabric layer laid over the spacer layer. The pattern layer forms a moire pattern using at least one first pattern unit and at least one second pattern unit. When the fabric is observed through the mesh fabric layer in a first viewing direction toward the base, the at least one first pattern unit is visible because the mesh fabric layer covers the at least one second pattern unit. When the fabric is observed through the mesh fabric layer in a second viewing direction toward the base, the at least one second pattern unit is visible because the at least one first pattern unit is covered instead.

### BACKGROUND OF THE INVENTION

### 1. Technical Field

The present invention relates to a fabric structure and more particularly to a fabric with a dynamic visual effect created jointly by a moire pattern and a mesh fabric layer.

### 2. Description of Related Art

A piece of fabric can be visually enhanced by incorporating decorative designs, patterns, and/or colors into the fabric, or by varying its weaving technique(s) or arrangement of material(s). If it is desired to further impart a dynamic visual effect to the fabric, an additional device or component (e.g., a three-dimensional projector) will be required, which however entails extra work and increases the cost of the fabric.

The inventor of the present invention, therefore, considered using the visual effect of a moire pattern to add a dynamic effect to the look of fabric. Referring to FIG. 1-1 through FIG. 1-3, a moire pattern is formed by superimposing at least two grate-like stripe patterns in an intersecting manner such that visual interference takes place. Since the components of common fabric are incapable of moving with respect to one another, difficulties arise if a moire pattern is to be integrated into such static fabric to produce a dynamic visual effect.

### BRIEF SUMMARY OF THE INVENTION

In light of the above, it is an objective of the present invention to provide a fabric which can produce a dynamic visual effect by a moire pattern and a mesh fabric layer.

To achieve this objective, the present invention provides a fabric which includes a base, a pattern layer, a spacer layer, and a mesh fabric layer. The pattern layer is provided on the base and forms a moire pattern using at least one first pattern unit and at least one second pattern unit. The spacer layer is provided on the pattern layer. The mesh fabric layer is laid over the spacer layer such that a predetermined spacing is formed between the pattern layer and the mesh fabric layer. When the fabric is observed through the mesh openings of the mesh fabric layer in a first viewing direction toward the base, the at least one first pattern unit can be seen because the mesh fabric layer covers the at least one second pattern unit. When the fabric is observed through the mesh openings of the mesh fabric layer in a second viewing direction toward the base, the at least one second pattern unit can be seen because the mesh fabric layer covers the at least one first pattern unit.

Preferably, the spacer layer is provided on the base and is adjacent to the at least one first pattern unit or the at least one second pattern unit.

Preferably, the spacer layer is composed of a plurality of protuberances which are spaced from one another. More preferably, the spacer layer is composed of transparent components, opaque components, or translucent components.

Preferably, the spacer layer is composed of a sheet-like transparent or translucent component. More preferably, the mesh fabric layer is printed on the spacer layer.

The structure, assembly features, and intended effects of the fabric of the present invention will be described in more detail below.

### BRIEF DESCRIPTION OF THE SEVERAL VIEWS OF THE DRAWINGS

FIG. 1-1 schematically shows a first pattern which can be used to form a conventional moire pattern;

FIG. 1-2 schematically shows a second pattern which can be used to form a conventional moire pattern;

FIG. 1-3 schematically shows how the first pattern in FIG. 1-1 and the second pattern in FIG. 1-2 form a conventional moire pattern;

FIG. 2 is a partial perspective view of the first preferred embodiment of the present invention;

FIG. 3 schematically shows certain components of the first preferred embodiment of the present invention, as seen in a first viewing direction;

FIG. 4 schematically shows certain components of the first preferred embodiment of the present invention, as seen from a second viewing direction;

FIG. 5 is a schematic partial sectional view of the first preferred embodiment of the present invention;

FIG. 6 is a schematic partial perspective view of the second preferred embodiment of the present invention; and

FIG. 7 is a schematic partial sectional view of the third preferred embodiment of the present invention.

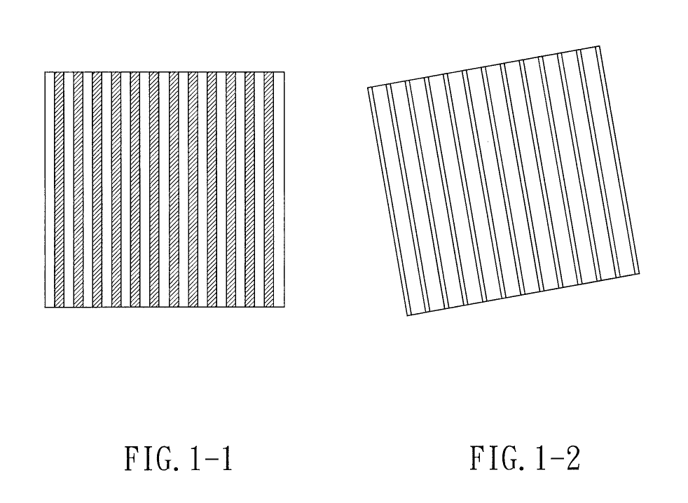

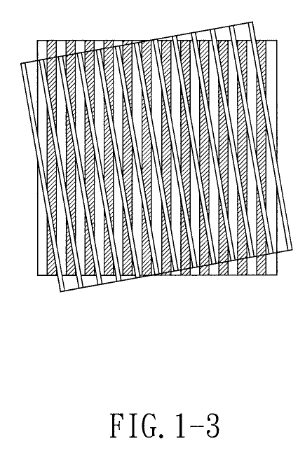

### DETAILED DESCRIPTION OF THE INVENTION

A detailed description of the structural features and anticipated effects of the present invention is given below with reference to some illustrative embodiments and the accompanying drawings. Please note that the same reference numerals used in the embodiments and the drawings refer to the same or similar elements, components, objects, structures, systems, architectures, devices, process flows, methods, or steps.

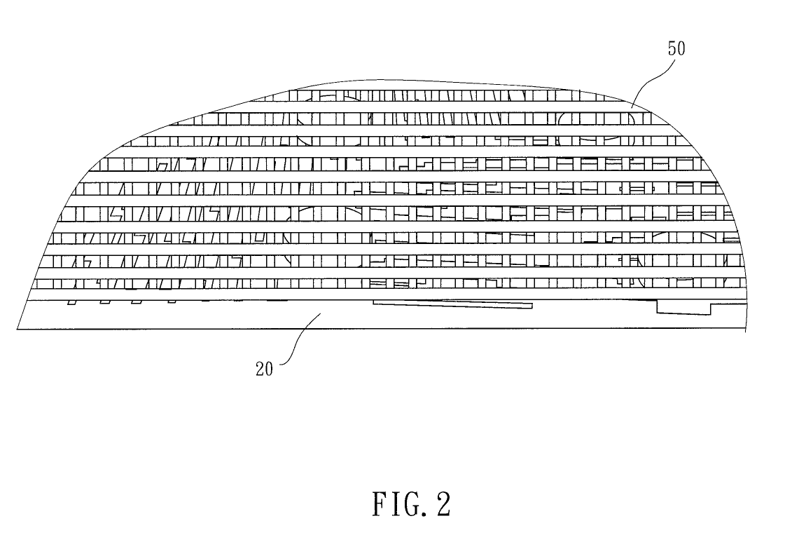

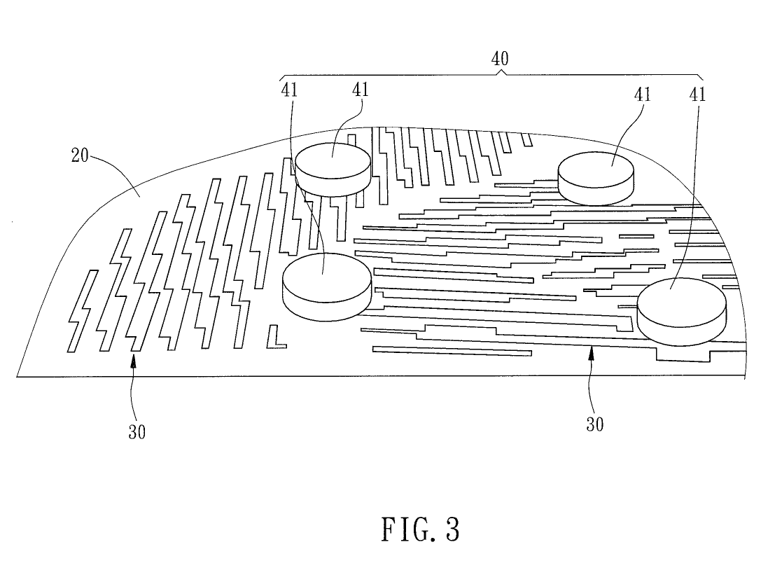

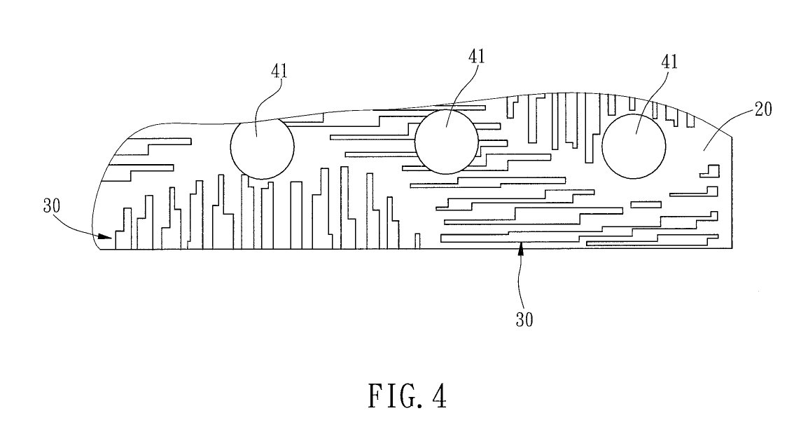

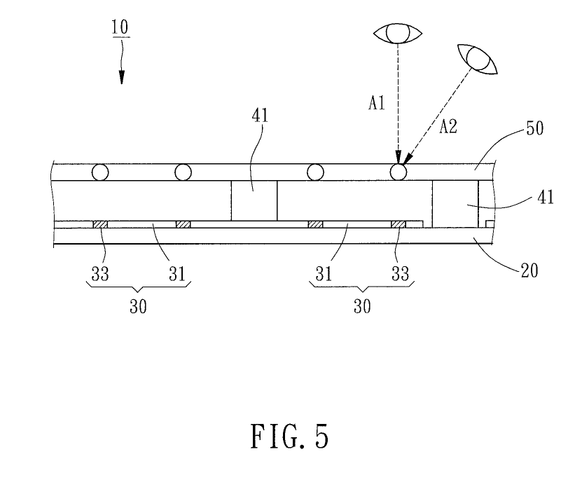

Referring to FIG. 2 to FIG. 5, the fabric 10 in the first preferred embodiment of the present invention includes a base 20, a pattern layer 30, a spacer layer 40, and a mesh fabric layer 50.

The base 20 is composed of woven or non-woven fabric.

The pattern layer 30 is provided on the base 20 and forms a moire pattern using at least one first pattern unit 31 and at least one second pattern unit 33. In the first preferred embodiment of the present invention, the pattern layer 30 forms a moire pattern by, for example and without limitation, interlacing the at least one first pattern unit 31 with the at least one second pattern unit 33. Preferably, the height of the at least one first pattern unit 31 of the pattern layer 30 with respect to the base 20, which serves as a reference plane, is less than the height of the at least one second pattern unit 33 with respect to the base 20. More preferably, the total area of the pattern layer 30 is less than or equal to the total area of the base 20. In the present invention, a moire patter refers to a visually interlaced pattern formed by dividing the first and the second pattern units 31 and 33 along the same axial direction into a plurality of stripes and interlacing the stripes thus formed. The foregoing design, however, imposes no limitations on the technical features claimed herein.

The spacer layer 40 is provided on the pattern layer 30. In the first preferred embodiment of the present invention, the spacer layer 40 is composed of a plurality of protuberances 41, which are spaced from one another. The protuberances 41 of the spacer layer 40 can be composed of transparent, opaque, or translucent components, and the material of such components may include but is not limited to glass, plastic, or silicone. It should be pointed out that the aforesaid materials impose no limitations on the technical features of the first preferred embodiment of the present invention. The protuberances 41 of the spacer layer 40 may be provided on the base 20 and be adjacent to the at least one first pattern unit 31 or the at least one second pattern unit 33 of the pattern layer 30.

The mesh fabric layer 50 is laid over the spacer layer 40 such that the pattern layer 30 and the mesh fabric layer 50 are spaced apart by a predetermined spacing. In the first preferred embodiment of the present invention, the mesh fabric layer 50 is a lattice-like fabric formed by weaving woven or non-woven fabric so that the pattern layer 30 is visible through the mesh openings of the mesh fabric layer 50.

The primary technical feature of the first preferred embodiment of the present invention is that the fabric can produce a dynamic visual effect based on a moire pattern.

That is to say, when a user observes the fabric 10 through the mesh openings of the mesh fabric layer 50 along a first viewing direction Al toward the base 20, he or she sees only the at least one first pattern unit 31 because the at least one second pattern unit 33 is visually shielded by the mesh fabric layer 50. When the user observes the fabric 10 through the mesh openings of the mesh fabric layer 50 along a second viewing direction A2 toward the base 20, he or she sees only the at least one second pattern unit 33 because the at least one first pattern unit 31 is visually shielded by the mesh fabric layer 50.

As the fabric 10 moves or swings, therefore, the user sees the at least one first pattern unit 31 and the at least one second pattern unit 33 of the pattern layer 30 alternately in the first viewing direction Al and the second viewing direction A2. Due to persistence of vision, the pattern layer 30 gives the impression that the moire pattern it forms produces a dynamic visual effect, and the objective and effects to be achieved by the present invention are thus attained.

Having disclosed the technical features and effects of the first preferred embodiment of the present invention, this specification now continues to describe the technical features and effects of the second preferred embodiment of the invention.

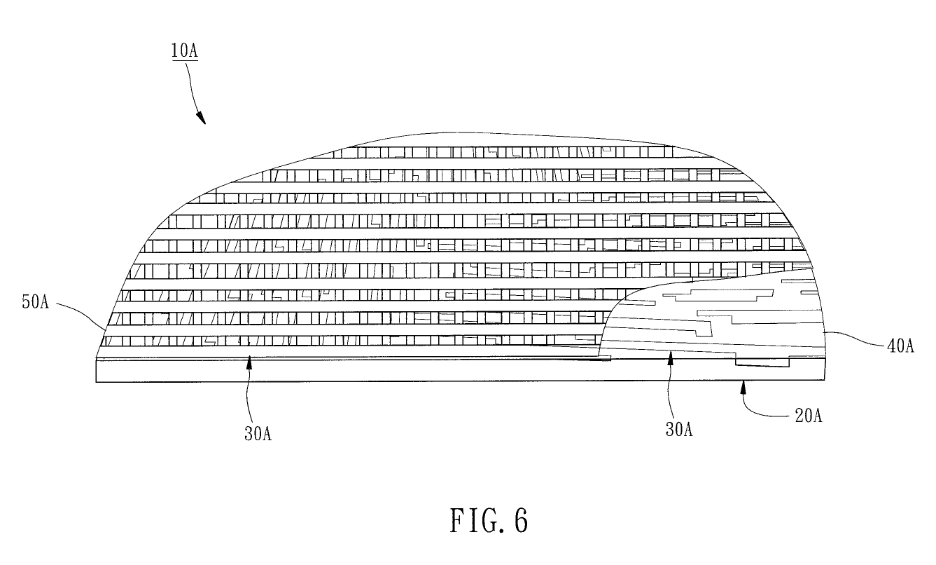

Referring to FIG. 6, the fabric 10A in the second preferred embodiment of the present invention has substantially the same structure as its counterpart in the previous embodiment by including a base 20A, a pattern layer 30A, a spacer layer 40A, and a mesh fabric layer 50A. The second preferred embodiment is different from the first in the following manner:

The spacer layer 40A overlying the pattern layer 30A is in the form of a sheet and is composed of a transparent or translucent component. Moreover, the mesh fabric layer 50A is printed on the spacer layer 40A.

As in the first preferred embodiment, the pattern layer 30A is provided on the base 20A, and the total area of the pattern layer 30A is less than or equal to that of the base 20A. The material of the spacer layer 40A may include but is not limited to glass, plastic, or silicone. Please note that the materials listed above are not intended to be restrictive of the technical features claimed herein.

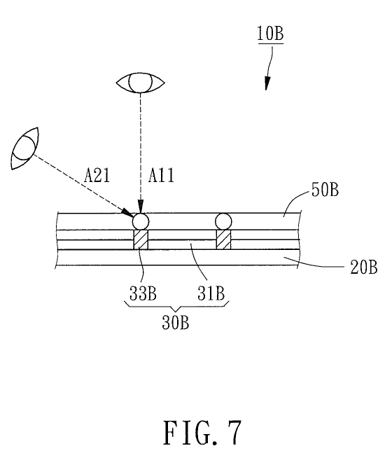

FIG. 7 shows the fabric 10B in the third preferred embodiment of the present invention. The fabric 10B has substantially the same structure as the fabrics disclosed in the first and the second embodiments, except for the following:

The mesh fabric layer 50B is laid directly over the pattern layer 30B, and the height of the at least one first pattern unit 31B of the pattern layer 30B with respect to the base 20B, which serves as a reference plane, is less than the height of the at least one second pattern unit 33B with respect to the base 20B.

The third preferred embodiment of the present invention lacks the spacer layers 40 and 40A, which are respectively used in the first and the second embodiments as a medium for creating a visual height difference. Instead, the at least one first pattern unit 31B or the at least one second pattern unit 33B of the pattern layer 30B is formed by three-dimensional printing or weaving such that a predetermined height difference is created between the at least one first pattern unit 31B and the at least one second pattern unit 33B.

As in the previous embodiments, when a user observes the fabric 10B through the mesh openings of the mesh fabric layer 50B in a first viewing direction Al 1 toward the base 20B, he or she sees only the at least one first pattern unit 31B because the at least one second pattern unit 33B is visually shielded by the mesh fabric layer 50B; and when the user observes the fabric 10B through the mesh openings of the mesh fabric layer 50B in a second viewing direction A21 toward the base 20B, he or she sees only the at least one second pattern unit 33B because the at least one first pattern unit 31B is visually shielded by the mesh fabric layer 50B.

When the fabric 10B moves or swings, therefore, the user sees the at least one first pattern unit 31B and the at least one second pattern unit 33B of the pattern layer 30B alternately in the first viewing direction All and the second viewing direction A21, and due to persistence of vision, the pattern layer 30B gives the impression that the moire pattern it forms produces a dynamic visual effect.

As a person of ordinary skill in the art would understand, the detailed description and embodiments provided herein serve only to demonstrate the structures, methods, process flows, and intended effects of the present invention but not to limit the scope of the invention. All equivalent substitutions or variations of the disclosed elements, components, objects, structures, devices, methods, or process flows should fall within the scope of the invention.

What is claimed is:

1. A fabric, comprising:
a base;
a pattern layer provided on the base, the pattern layer forming a moire pattern using at least one first pattern unit and at least one second pattern unit;
a spacer layer provided on the pattern layer; and
a mesh fabric layer laid over the spacer layer such that a predetermined spacing is formed between the pattern layer and the mesh fabric layer;
wherein when the fabric is observed through mesh openings of the mesh fabric layer in a first viewing direction toward the base, the at least one first pattern unit is visible because the mesh fabric layer covers the at least one second pattern unit; and when the fabric is observed through the mesh openings of the mesh fabric layer in a second viewing direction toward the base, the at least one second pattern unit is visible because the mesh fabric layer covers the at least one first pattern unit.

2. The fabric of claim 1, wherein the spacer layer is provided on the base and is adjacent to the at least one first pattern unit or the at least one second pattern unit.

3. The fabric of claim 1, wherein the spacer layer is composed of a plurality of protuberances spaced from one another.

4. The fabric of claim 2, wherein the spacer layer is composed of a plurality of protuberances spaced from one another.

5. The fabric of claim 3, wherein the protuberances of the spacer layer are composed of transparent, opaque, or translucent components.

6. The fabric of claim 4, wherein the protuberances of the spacer layer are composed of transparent, opaque, or translucent components.

7. The fabric of claim 1, wherein the spacer layer is composed of a sheet-like transparent or translucent component.

8. The fabric of claim 2, wherein the spacer layer is composed of a sheet-like transparent or translucent component.

9. The fabric of claim 7, wherein the mesh fabric layer is printed on the spacer layer.

10. The fabric of claim 8, wherein the mesh fabric layer is printed on the spacer layer.

11. A fabric, comprising:
a base;
a pattern layer provided on the base, the pattern layer forming a moire pattern using at least one first pattern unit and at least one second pattern unit, wherein the at least one first pattern unit has a first height with respect to the base, the at least one second pattern unit has a second height with respect to the base, and the first height is less than the second height; and
a mesh fabric layer laid over the pattern layer such that a predetermined spacing is formed between the pattern layer and the mesh fabric layer;
wherein when the fabric is observed through mesh openings of the mesh fabric layer in a first viewing direction toward the base, the at least one first pattern unit is visible because the mesh fabric layer covers the at least one second pattern unit; and when the fabric is observed through the mesh openings of the mesh fabric layer in a second viewing direction toward the base, the at least one second pattern unit is visible because the mesh fabric layer covers the at least one first pattern unit.
